(19) United States
(12) Patent Application Publication
(10) Pub. No.: US 2005/0156127 A1
(43) Pub. Date: Jul. 21, 2005

(54) Pneumatic valve for braking systems

(76) Inventor: Leonardo Caddedu, Crema (IT)

Correspondence Address: Leo H McCormick Jr;Bosch Braking Systems, 2112 Mishawaka Avenue, P O Box 4721, South Bend, IN, 46634-4721, US

(21) Appl. No.: 10/516,056

(22) PCT Filed: May 26, 2003
(86) PCT No.: PCT/EP03/05479

(30) Foreign Application Priority Data
May 29, 2002 (IT) TO 2002A000452

(51) Int. Cl. F16K 31/145; F16K 31/165; F16K 31/365; F16K 31/385

(52) U.S. Cl. 251/61.4

(57) ABSTRACT

A pneumatic valve for limiting the pressure level of a fluid between a pneumatic component (5) and a vacuum source (3). The valve has a casing (11) with a skirt (21) that is mounted to divide the casing (11) into a first chamber (17) and a second chamber (19) with a first orifice (13) that allows a supply of fluid from the vacuum source (3) to the first chamber (17), a second orifice (15) connecting the first chamber (17) with the pneumatic component (5) and a third orifice (23) that allows a high pressure pneumatic fluid to be supplied to the second chamber (19). An elastic member (27) interposed in the first chamber (17) between the skirt (21) and the casing (11) in the first chamber (17) at least one connecting orifice (13, 15) and thereby control communication of fluid between the vacuum source (3) and the pneumatic component (5).

### BACKGROUND OF THE INVENTION

The present invention principally relates to a pneumatic valve for limiting the level of depression and in particular to a pneumatic valve for limiting the level of low pressure allowing increased control of the low pressure level existing inside at least one of the chambers of a pneumatic braking assistance servomotor, and to a braking system comprising such a valve.

The sources of depression, also referred to as vacuum sources, for pneumatic braking assistance servomotors of known type comprise a pneumatic vacuum pump, for example a vane pump and in particular a single vane pump, comprising a first chamber for drawing in pneumatic fluid contained in a chamber of the servomotor, called the low pressure chamber, and a second chamber for delivering the said pneumatic fluid coming from the low pressure chamber of the servomotor, called the expulsion chamber.

Devices are also known for which the vacuum source is provided by the engine depression of a gasoline engine of the vehicle comprising the said servomotor.

Both the vacuum pump and the engine depression make it possible to achieve a non-controllable value of low pressure and, in particular for the engine depression, the low pressure level is likely to vary according to variations in the operating conditions of the engine.

Furthermore, it is sometimes necessary to limit the pressure level of the pneumatic fluid supplied to the servomotor to a predetermined value that is higher than the low pressure value that can be achieved due to the vacuum source in order to avoid operating problems of the servomotor because of too great a pressure difference between the two chambers of the servomotor.

It is known to provide the regulation of the pressure level existing inside at least one chamber of a servomotor by using a pressure sensor measuring the pressure existing inside the low pressure chamber of the servomotor and allowing the control of an electro-valve interrupting the connection between the servomotor and the vacuum source. The pressure value data measured by the pressure sensor is transmitted to an electronic computer which sends an appropriate command to the electro-valve. However, these devices are of high cost price due to the price of a pressure sensor, the price of the electro-valve and the complexity of fitting the sensor in the servomotor and of the electrical connection to the computer. Furthermore, the installation of the pressure sensor necessitates an orifice formed in the casing of the servomotor, the fluid-tightness being provided for example by a seal. Now, due to the fact of the deformation of the casing of the servomotor during a braking phase, the presence of orifices in the casing is likely to be the source of leakages reducing the efficiency of the servomotor and reducing the driver's comfort without however these things being dangerous for the driver.

### SUMMARY OF THE INVENTION

Consequently, an objective of the present invention is to offer a reliable and easily fitted means of limiting, in a component using a low pressure pneumatic fluid obtained by means of a vacuum source, the value of the pressure of the said pneumatic fluid to a predetermined value that is higher than the pressure value obtained with a vacuum source.

Another objective of the present invention is to offer such a means furthermore having a low cost price.

These objectives are achieved by a valve comprising valve means, disposed between a vacuum source and a component using a low pressure pneumatic fluid obtained from the vacuum source, the valve means being sensitive to the variation in the pressure level obtained from the vacuum source and interrupting the intake of the pneumatic fluid into the component from the vacuum source when the detected pressure level is lower than a predetermined value.

In other words, it is a valve comprising an obturator subjected on a first of its faces to a low pressure and on a second face, opposite to the first face, to a high pressure, the said obturator being mobile under the effect of the pressure difference and capable of interrupting the connection between the vacuum source and the component at a predetermined value of pressure difference.

The present invention principally relates to a pneumatic valve for limiting the pressure level of a pneumatic fluid obtained from a low pressure pneumatic fluid source by a pneumatic component using the said pneumatic fluid characterized in that the said valve comprises a casing in which a skirt is mounted in a fluid-tight sliding manner, the said skirt dividing the interior of the casing into a first chamber and a second chamber, the said casing comprising a first orifice allowing the supply of the first chamber from the low pressure pneumatic fluid source, a second orifice connecting the first chamber and the component and a third orifice allowing the supply of the second chamber with high pressure pneumatic fluid, the first chamber also comprising elastic means of returning the skirt interposed between the skirt and the casing, the said skirt comprising means of obturating at least one connecting orifice between the vacuum source and the pneumatic component.

The present invention also relates to a pneumatic valve characterized in that the skirt comprises an obturator capable of cooperating with a seat formed on the periphery of the first connection orifice between the first chamber and the low pressure pneumatic fluid source.

The present invention also relates to a pneumatic valve characterized in that the obturator is mounted such that it protrudes from the skirt into the first chamber.

The present invention also relates to a pneumatic valve characterized in that the obturator comprises an elastomer cap in order to enhance the fluid-tightness of the contact between the obturator and the seat.

The present invention also relates to a pneumatic valve characterized in that the fluid-tightness between the first pneumatic chamber and the second pneumatic chamber is produced by means of an unrolling membrane fixed both to the casing and to the skirt.

The present invention also relates to a pneumatic valve characterized in that the skirt comprises a first disk and a second disk, fixed to each other, and in that the unrolling membrane is clamped between the first disk and the second disk.

The present invention also relates to a pneumatic valve characterized in that the high pressure pneumatic fluid existing in the second pneumatic chamber is air at atmospheric pressure.

The present invention also relates to a braking system comprising a pneumatic braking assistance servomotor, a master cylinder connected in a fluid-tight manner to at least one brake disposed at wheel level and a vacuum source characterized in that it comprises a pneumatic valve according to the present invention connected in a fluid-tight manner to the low pressure pneumatic fluid source and to the servomotor, the said servomotor forming the pneumatic component.

The present invention also relates to a braking system characterized in that the said low pressure pneumatic fluid source is an air intake of a combustion engine.

The present invention also relates to a braking system characterized in that the said low pressure pneumatic fluid source is a pump provided with at least one vane driven by an electric motor.

The present invention also relates to a braking system characterized in that the said low pressure pneumatic fluid source is a pump having at least one vane driven by the engine of a vehicle equipped with the said braking system.

The present invention will be better understood with the help of the following description and of the appended figures given as non-limitative examples and in which the front and the rear respectively correspond to the left and the right of the drawings.

### BRIEF DESCRIPTION OF THE INVENTION

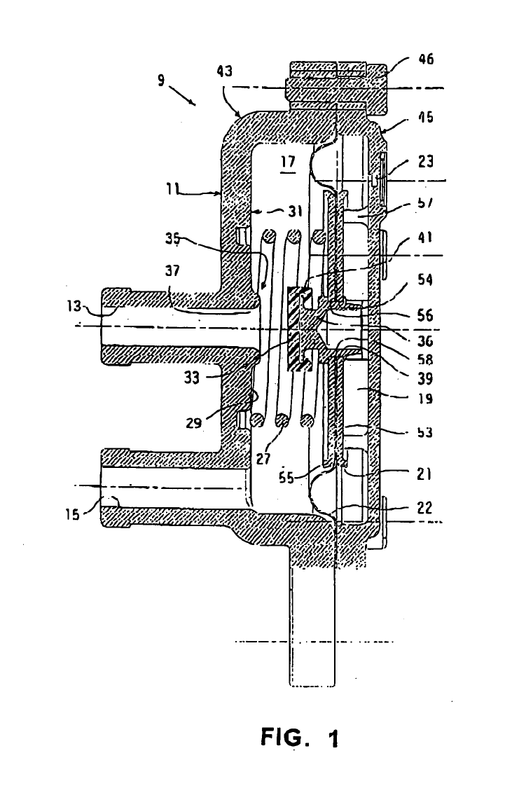

FIG. 1 is a detailed cross-sectional view of a pneumatic valve for limiting the low pressure level according to the present invention; and

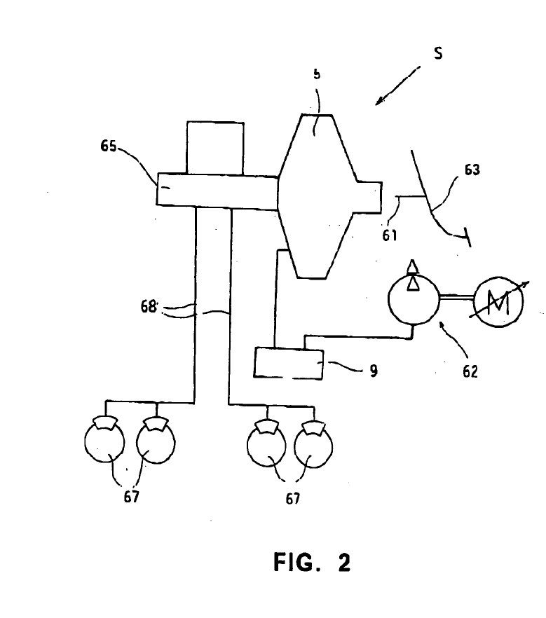

FIG. 2 is a diagram of a braking system comprising a valve for limiting the low pressure level according to FIG. 1.

### DETAILED DESCRIPTION OF THE INVENTION

The terms “vacuum” and “depression” applied to pressure levels correspond, for example for a pneumatic braking assistance servomotor, to pressures lower than atmospheric pressure and in particular to pressures of between 0 Pa and 95000 Pa.

In FIG. 1 there can be seen a valve 9 according to the present invention comprising a casing 11 provided with first and second connecting orifices 13, 15, respectively connected in a fluid-tight manner to a vacuum source, for example a vacuum pump or the air intake of a combustion engine (not shown), and to a component using a low pressure pneumatic fluid (not shown), for example a pneumatic braking assistance servomotor, the depression source and the servomotor being connected in a fluid-tight manner by a supply pipe (not shown), the connection between the depression source and the element using the low pressure pneumatic fluid being able to be obturated in a fluid-tight manner by the valve 9 for a pressure value lower than a predetermined value P.

The casing 11 is advantageously formed by a bowl 43, forming the front wall 31 of the casing 11 and in which are formed the orifices 13 and 15, and a cover 45 forming the rear wall of the casing 11, the bowl 43 and the cover 45 being connected to each other in a fixed manner, for example by a nut and bolt system.

The valve also comprises first and second pneumatic chambers, 17, 19, separated in a fluid-tight manner by a skirt 21 mounted such that it slides in the casing 11, the fluid-tightness being produced by an unrolling membrane 22 fixed both to the casing and to the skirt 21, the membrane advantageously being made of elastomer, for example of rubber. Provision could however be made for the fluid-tightness to be provided by a seal mounted on the outer radial periphery of the skirt 21 and sliding over the internal wall of the casing or by any other fluid-tightness means.

In the example shown, the fluid-tightness between the bowl 43 and the cover 45 is provided by the radially outer extremity of the unrolling membrane 22 by clamping between a radially outer extremity of the cover 45 and a radially outer extremity of the bowl 43.

It is possible however to envisage providing the fluid-tightness by a seal, for example a flat seal clamped between the radially outer extremities of the bowl 43 and of the cover 45.

The first pneumatic chamber 17, which will be called the front chamber, is connected to the depression source 3 and with the component by the first and second orifices 13 and 15 respectively.

The second pneumatic chamber 19, or rear chamber, is supplied with a high pressure pneumatic fluid, for example at atmospheric pressure. In the example shown, the second chamber 19 is connected to the external environment and is supplied with air at atmospheric pressure through a third orifice 23 formed in the cover 45 of the casing.

An elastic return means 27, advantageously a cylindrical spring, is disposed in the front chamber 17 and is fitted such that it is compressed between the skirt 21 and a rear face 29 of the bowl 43 of the casing 11.

The valve also comprises an obturator 33 carried by the skirt 21 and a seat 35 capable of receiving the obturator 33 when the valve 9 closes the connection between the vacuum source and the component supplied with depression.

In the exemplary embodiment shown, the seat 35 is formed by an annular protrusion 37 surrounding the orifice 13 connecting the interior of the front chamber 17 and the vacuum fluid source 3. It is of course possible to envisage obturating the second connection orifice 15 between the chamber 17 and the provided source 3 instead of obturating the first orifice 13, or to obturate the first 13 and second 15 connecting orifices simultaneously.

The obturator 33 is preferably attached in a fixed manner to the skirt 21 and comes into contact with the seat 35, the obturator 33 advantageously being formed by a substantially cylindrical part 36 protruding into the chamber 17 from the skirt 21.

In the embodiment shown, the skirt 21 comprises a passage 39 in which the part 36 is mounted in a fixed manner by crimping. It is possible however to provide for the part 36 to be fixed to the skirt by gluing or screwing.

It is also possible to envisage providing for the skirt 21 to directly form an obturator and to be applied against the seat 35; for example the obturator would be formed by stamping if it is necessary for the obturator to protrude from the principal plane containing the skirt 21.

The obturator 33 advantageously comprises a part made of rubber 41 for the obturating, forming a cap and covering the front longitudinal extremity of the cylindrical part 36 in order to enhance the fluid-tightness of the contact between the obturator 33 and the seat 35.

The skirt 21 is advantageously formed by first and second disks 53, 55 joined together in a fixed manner. In the example shown, the first and second disks respectively comprise a central orifice 54, 56 in which the part 36 forming an obturator 33 is mounted in a traversing manner, the holding of the first and second disks 53, 55 together being achieved for example by

The valve also comprises first and second pneumatic chambers, 17, 19, separated in a fluid-tight manner by a skirt 21 mounted such that it slides in the casing 11, the fluid-tightness being produced by an unrolling membrane 22 fixed both to the casing and to the skirt 21, the membrane advantageously being made of elastomer, for example of rubber. Provision could however be made for the fluid-tightness to be provided by a seal mounted on the outer radial periphery of the skirt 21 and sliding over the internal wall of the casing or by any other fluid-tightness means.

In the example shown, the fluid-tightness between the bowl 43 and the cover 45 is provided by the radially outer extremity of the unrolling membrane 22 by clamping between a radially outer extremity of the cover 45 and a radially outer extremity of the bowl 43.

It is possible however to envisage providing the fluid-tightness by a seal, for example a flat seal clamped between the radially outer extremities of the bowl 43 and of the cover 45.

The first pneumatic chamber 17, which will be called the front chamber, is connected to the depression source 3 and with the component by the first and second orifices 13 and 15 respectively.

The second pneumatic chamber 19, or rear chamber, is supplied with a high pressure pneumatic fluid, for example at atmospheric pressure. In the example shown, the second chamber 19 is connected to the external environment and is supplied with air at atmospheric pressure through a third orifice 23 formed in the cover 45 of the casing.

An elastic return means 27, advantageously a cylindrical spring, is disposed in the front chamber 17 and is fitted such that it is compressed between the skirt 21 and a rear face 29 of the bowl 43 of the casing 11.

The valve also comprises an obturator 33 carried by the skirt 21 and a seat 35 capable of receiving the obturator 33 when the valve 9 closes the connection between the vacuum source and the component supplied with depression.

In the exemplary embodiment shown, the seat 35 is formed by an annular protrusion 37 surrounding the orifice 13 connecting the interior of the front chamber 17 and the vacuum fluid source 3. It is of course possible to envisage obturating the second connection orifice 15 between the chamber 17 and the provided source 3 instead of obturating the first orifice 13, or to obturate the first 13 and second 15 connecting orifices simultaneously.

The obturator 33 is preferably attached in a fixed manner to the skirt 21 and comes into contact with the seat 35, the obturator 33 advantageously being formed by a substantially cylindrical part 36 protruding into the chamber 17 from the skirt 21.

In the embodiment shown, the skirt 21 comprises a passage 39 in which the part 36 is mounted in a fixed manner by crimping. It is possible however to provide for the part 36 to be fixed to the skirt by gluing or screwing.

It is also possible to envisage providing for the skirt 21 to directly form an obturator and to be applied against the seat 35; for example the obturator would be formed by stamping if it is necessary for the obturator to protrude from the principal plane containing the skirt 21.

The obturator 33 advantageously comprises a part made of rubber 41 for the obturating, forming a cap and covering the front longitudinal extremity of the cylindrical part 36 in order to enhance the fluid-tightness of the contact between the obturator 33 and the seat 35.

The skirt 21 is advantageously formed by first and second disks 53, 55 joined together in a fixed manner. In the example shown, the first and second disks respectively comprise a central orifice 54, 56 in which the part 36 forming an obturator 33 is mounted in a traversing manner, the holding of the first and second disks 53, 55 together being achieved for example by crimping, more particularly by plastic deformation of the outer periphery of the part 36 around the orifices 54, 56. A central orifice 58 is also provided in the unrolling membrane 22, the orifice 58 being of diameter substantially equal to that of the orifices 54, 56 of the disks 53, 55 and allowing the passage of the obturator 33 and the fixing of the membrane 22 between the first and second disks 53, 55 by clamping.

This example of embodiment advantageously makes it possible, in a simple manner, to mount the obturator on the skirt and to mount the membrane 22 in a fluid-tight manner on the skirt.

In the rest state, the skirt 21 advantageously bears on pins 57 formed on the internal surface of the cover 45.

In FIG. 2 there can be seen an overall diagram of a braking system S comprising a valve 9 according to the present invention. The braking system S according to the present invention comprises a pneumatic braking assistance servomotor 5 forming the component using low pressure air and controlled by an actuating rod 61 connected to a brake pedal 63 that can be actuated by the driver, a master cylinder 65 disposed, with respect to the servomotor 5, on the side opposite to that of the brake pedal 63 and fixed to the said servomotor and receiving the assistance provided by the latter by the intermediary of a thrust rod (not shown).

The master cylinder 65 is connected in a fluid-tight manner by hydraulic pipes 68 to at least one brake 67 disposed at wheel level, and advantageously to four brakes on four wheels. The pneumatic braking assistance servomotor 5 comprises a depression chamber (not visible) connected in a fluid-tight manner to a vacuum source 3, for example an electric vacuum pump. Between the vacuum pump 3 and the depression chamber of the servomotor there is disposed the valve 9 according to the present invention, the connection of the valve 9 to the vacuum pump 3 and to the servomotor 5 is identical to that described with reference to FIG. 2.

The valve 9 according to the present invention is advantageously fixed to the casing of the servomotor 5 or to the casing of the vacuum source in the case where the source 3 is a vacuum pump.

In the diagram shown in FIG. 2, the valve 9 is not shown as being integral with the servomotor or with the vacuum pump in order to make the diagram more clear.

The functioning of a servomotor and of a master cylinder and the cooperation of the servomotor with the master cylinder will not be described in greater detail as they are well known to those skilled in the art.

The functioning of the said valve in a braking system according to FIG. 3 will now be described.

For an air pressure value obtained by the vacuum pump higher than a predetermined value P, the depression chamber is connected with the vacuum pump 3 by the intermediary of the chamber 17 of the valve 9 according to the present invention.

When the pressure provided by the vacuum source 3 is lower than the predetermined value P, and therefore the pressure existing inside the chamber 17 is lower than the predetermined value P, the skirt 21 moves in translation towards the front under the effect of the differential pressure existing between the chambers 17 and 19, carrying the obturator 33 which becomes applied against the seat 35 and interrupts the connection between the source 3 and the servomotor 5. Thus, the pressure existing in the chamber 2 of the servomotor is substantially fixed at the predetermined value P.

When the pressure in the chamber 17 increases, that is to say when the servomotor is called upon during a braking phase, and when the pressure in the depression chamber 17 becomes higher than the predetermined value P, the obturator 33 detaches from the seat 35 allowing a connection between the vacuum source 3 and the depression chamber 62 of the servomotor 5 by the vacuum source 3. And this continues until the value of the pressure existing inside the chamber 17 becomes lower than the predetermined value P.

The opening and closing of the valve 9 and consequently the predetermined pressure value P is equal to the product of the area of the skirt and the pressure difference existing between the chambers 17 and 19 less the load of the spring 27 at the moment the obturator 33 comes into contact with the seat 35. It is thus easy to modify the predetermined value P for closing and opening the valve by modifying the load of the spring 27.

In the preferred embodiment, the spring 27 is a single cylindrical coil spring but a multiple coil spring, a single or double conical spring or any other type of elastic return means is of course suitable.

The geometry of the elastic means 27 makes it possible, for a pressure value higher than P, to allow a lifting of the obturator 33 with respect to the seat 35 avoiding any loss of pressure between the servomotor 5 and the depression source 3.

The valve according to the present invention of course applies to any system functioning with a low pressure pneumatic fluid and necessitating a limiting of the value of the low pressure to a bottom value, for example 95000 Pa.

There has been produced a pneumatic valve, for limiting the pressure level in a depression chamber of a pneumatic braking assistance servomotor, that is simple and reliable and whose fitting in a braking system of known type is simplified.

The present invention applies in particular to the automobile industry.

The present invention applies principally to the industry producing braking systems for motor vehicles and in particular for private automobiles.

1. A pneumatic valve for limiting the pressure level of a pneumatic fluid obtained from a low pressure pneumatic fluid source (3) by a pneumatic component (5) using the said pneumatic fluid characterized in that the said valve comprises a casing (11) in which a skirt (21) is mounted in a fluid-tight sliding manner, the said skirt dividing the interior of the casing (11) into a first chamber (17) and a second chamber (19), the said casing comprising a first orifice (13) allowing the supply of the first chamber (17) from the low pressure pneumatic fluid source (3), a second orifice (15) connecting the first chamber (17) and the component (5) and a third orifice (23) allowing the supply of the second chamber (19) with high pressure pneumatic fluid, the first chamber (17) also comprising elastic means (27) of returning the skirt (21) interposed between the skirt (21) and the casing (11), the said skirt (21) comprising means (33, 41) of obturating at least one connecting orifice (13, 15) between the vacuum source (3) and the pneumatic component (5).

2. The pneumatic valve according to claim 1, characterized in that the skirt (21) comprises an obturator (33) capable of cooperating with a seat (35) formed on the periphery of the first connection orifice (13) between the first chamber (17) and the low pressure pneumatic fluid source (3).

3. The pneumatic valve according to claim 2, characterized in that the obturator (33) is mounted such that it protrudes from the skirt (21) into the first chamber (17).

4. The pneumatic valve according to claim 3, characterized in that the obturator (33) comprises an elastomer cap (41) in order to enhance the fluid-tightness of the contact between the obturator (33) and the seat (35).

5. The pneumatic valve according to claim 4, characterized in that the fluid-tightness between the first pneumatic chamber (17) and the second pneumatic chamber (19) is produced by means of an unrolling membrane (22) fixed both to the casing (11) and to the skirt (21).

6. The pneumatic valve according to claim 5, characterized in that the skirt (21) comprises a first disk (53) and a second disk (55), fixed to each other, and in that the unrolling membrane (22) is clamped between the first disk (53) and the second disk (55).

7. The pneumatic valve according to claim 6, characterized in that the high pressure pneumatic fluid existing in the second pneumatic chamber (19) is air at atmospheric pressure.

8. The pneumatic valve for use in a pneumatic braking assistance servomotor (5) having a master cylinder (65) connected in a fluid-tight manner to at least one brake (67) disposed at wheel level and a vacuum source (3), said pneumatic valve being connected in a fluid-tight manner to said vacuum source (3) and to said servomotor (5).

9. The pneumatic valve according to claim 8, characterized in that the said vacuum source (3) is an air intake of a combustion engine.

10. The pneumatic valve according to claim 8, characterized in that the said vacuum source (3) is a pump provided with at least one vane driven by an electric motor.

11. The pneumatic valve according to claim 8, characterized in that the said vacuum source (3) is a pump having at least one vane driven by the engine of a vehicle equipped with the said braking system.
